(19) United States
(12) Patent Application Publication
(10) Pub. No.: US 2025/0035861 A1
(43) Pub. Date: Jan. 30, 2025

(54) OPTICAL CONNECTION STRUCTURE

(71) Applicant: Fujikura Ltd., Tokyo (JP)

(72) Inventors: Hau Huu Tran, Sakura-shi (JP); Hirohisa Suda, Sakura-shi (JP); Kenji Sasaki, Sakura-shi (JP); Takaaki Ishikawa, Sakura-shi (JP)

(73) Assignee: Fujikura Ltd., Tokyo (JP)

(21) Appl. No.: 18/713,401

(22) PCT Filed: Jul. 7, 2022
(86) PCT No.: PCT/JP2022/026954

§ 371 Date: May 24, 2024

(30) Foreign Application Priority Data
Dec. 1, 2021 (JP) 2021-195701

(51) Int. Cl. G02B 6/38

(52) U.S. Cl. CPC G02B 6/3877

(57) ABSTRACT

An optical connection structure includes a first ferrule, a second ferrule, and a split sleeve that has an insertion hole into which at least part of the first ferule and at least part of the second ferule are inserted, in which the split sleeve has a first end in which the first ferrule is inserted and a second end in which the second ferrule is inserted, and when assuming that a dimension of a first taper surface is x1, a distance between a first connection end surface and the first end is y1, a dimension of the second taper surface is x2, and a distance between a second connection end surface and the second end is y2, the following expressions a, b, and c are established.

$$a : X = x 1 / x 2 \\ b : Y = y 1 / y 2 \\ c : ( 3 X + 2 ) / 5 < Y < ( 2 X + 3 ) / 4$$

### TECHNICAL FIELD

The present invention relates to an optical connection structure.

Priority is claimed on Japanese Patent Application No. 2021-195701, filed on Dec. 1, 2021, the content of which is incorporated herein by reference.

### BACKGROUND ART

Patent Document 1 discloses an optical connection structure having two ferrules. Each ferrule has a fiber hole through which an optical fiber is inserted. In this optical connection structure, connection end surfaces of the two ferrules come into contact with each other, and thus two optical fibers inserted through the fiber holes are optically connected.

### CITATION LIST

### Patent Document

[Patent Document 1]

Japanese Unexamined Patent Application, First Publication No. 2021-173963

### SUMMARY OF INVENTION

### Technical Problem

In the optical connection structure described in Patent Document 1, for example, when an external force is applied to the ferrule, axes misalignment may occur between the two ferrules. When such axes misalignment occurs, connection loss between the optical fibers inserted into the two ferrules may increase.

The present invention has been made in consideration of such circumstances, and an object of the present invention is to provide an optical connection structure capable of reducing an increase in connection loss.

### Solution to Problem

In order to solve the above problems, an optical connection structure according to an aspect of the present invention includes a first ferrule having a first connection end surface, a second ferrule having a second connection end surface that comes into contact with the first connection end surface, and a split sleeve that has an insertion hole into which at least part of the first ferule and at least part of the second ferule are inserted and has a C-shape in a transverse section perpendicular to a direction in which the insertion hole extends, in which the split sleeve has a first end in which the first ferrule is inserted and a second end which is located opposite to the first end and in which the second ferrule is inserted, the first ferule has a first fiber hole that penetrates the first ferule and a first taper surface that inclines such that a diameter thereof becomes gradually larger as a distance from an outer circumferential edge of the first connection end surface increases, the second ferrule has a second fiber hole that penetrates the second ferrule and a second taper surface that inclines such that a diameter thereof becomes gradually larger as a distance from an outer circumferential edge of the second connection end surface increases, and when assuming that a dimension of the first taper surface in a direction in which the first fiber hole extends is x1, a distance between the first connection end surface and the first end in the direction in which the first fiber hole extends is y1, a dimension of the second taper surface in a direction in which the second fiber hole extends is x2, and a distance between the second connection end surface and the second end in the direction in which the second fiber hole extends is y2, the following expressions a, b, and c are established.

$$a : X = x 1 / x 2 \\ b : Y = y 1 / y 2 \\ c : ( 3 X + 2 ) / 5 < Y < ( 2 X + 3 ) / 4$$

According to the aspect of the present invention, it is possible to reduce an increase in axes misalignment between the first ferrule and the second ferrule when an external force is applied to the ferrule. Thereby, it is possible to reduce an increase in connection loss between the optical fibers inserted into the first ferrule and the second ferrule.

Further, the optical connection structure may further include a support member that supports at least part of the first ferrule, and a housing that accommodates the split sleeve, the support member may have a first contacting surface facing the first end, the housing may have a second contacting surface facing the second end, and when assuming that a distance between the first end and the first contacting surface in the direction in which the first fiber hole extends is G1, and a distance between the second end and the second contacting surface in the direction in which the second fiber hole extends is G2, G1+G2≤0.45 mm may be established.

In this case, even when the ferrule is repeatedly inserted into and removed from the split sleeve, the movement of the split sleeve can be restricted. Thereby, the insertion lengths y1 and y2 of the ferrules into the split sleeve are less likely to change, and it is possible to more reliably reduce an increase in the connection loss between the optical fibers inserted into the first ferrule and the second ferrule.

Further, the second ferrule may be biased toward the first ferrule by a biasing member, and the first ferrule may not be biased toward the second ferrule.

In an optical connection structure in the related art, when one of two ferrules is biased by a biasing member and the other is not biased by the biasing member, axes misalignment is likely to increase. According to the aspect of the present invention, even in such a case, it is possible to reduce an axes misalignment increment between the first ferrule and the second ferrule, and to reduce an increase in the connection loss.

### Advantageous Effects of Invention

According to the above aspect of the present invention, it is possible to provide an optical connection structure capable of reducing an increase in connection loss.

### BRIEF DESCRIPTION OF DRAWINGS

FIG. 1 is a cross-sectional view showing an optical connection structure according to an embodiment of the present invention.

FIG. 2 is an enlarged view showing a portion of the optical connection structure shown in FIG. 1.

FIG. 3 is a cross-sectional view taken along line III-III shown in FIG. 2.

FIG. 4 is a view showing a state in which a connector is inserted into an adapter according to the embodiment of the present invention.

FIG. 5 is a graph showing a change in an axes misalignment increment Δ when a value of X and a value of Y are changed.

FIG. 6A is a diagram showing a first example of movement that may occur in the optical connection structure according to the embodiment of the present invention.

FIG. 6B is an enlarged view showing a portion of FIG. 6A.

FIG. 7A is a diagram showing a second example of movement that may occur in the optical connection structure according to the embodiment of the present invention.

FIG. 7B is an enlarged view showing a portion of FIG. 7A.

FIG. 8A is a diagram showing a third example of movement that may occur in the optical connection structure according to the embodiment of the present invention.

FIG. 8B is an enlarged view showing a portion of FIG. 8A.

### DESCRIPTION OF EMBODIMENTS

Hereinafter, an optical connection structure 1 according to an embodiment of the present invention will be described with reference to the drawings.

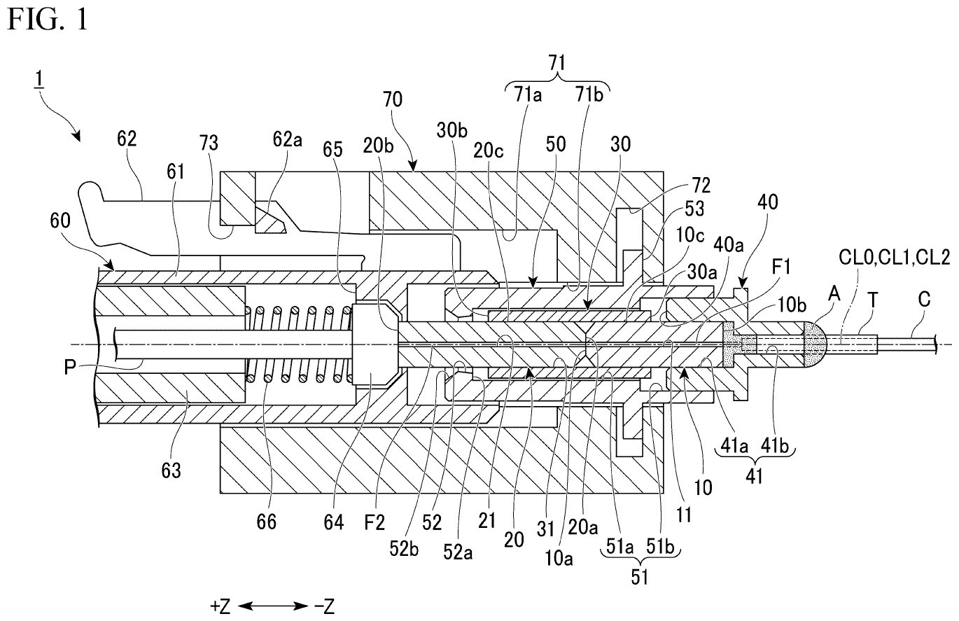

As shown in FIG. 1, the optical connection structure 1 includes a first ferrule 10, a second ferrule 20, a split sleeve 30, a support member 40, a housing 50, a connector 60, an adapter 70, a first fiber F1, and a second fiber F2. The first ferrule 10 is formed with a first fiber hole 11 which penetrates the first ferrule 10 and through which the first fiber F1 is inserted. The second ferrule 20 is formed with a second fiber hole 21 which penetrates the second ferrule 20 and through which the second fiber F2 is inserted. Further, the support member 40 supports at least part of the first ferrule 10. A through hole 41 is formed in the support member 40.

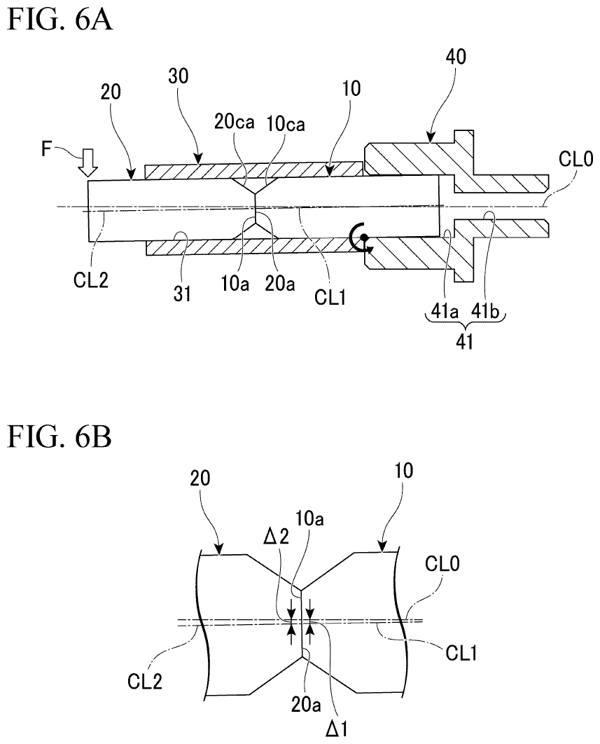

In the present specification, the central axis line of the through hole 41 of the support member 40 may be referred to as a reference central axis line CL0 (see also FIGS. 6A to 8B). Similarly, the central axis line of the first fiber hole 11 of the first ferrule 10 may be referred to as a first central axis line CL1. The central axis line of the second fiber hole 21 of the second ferrule 20 may be referred to as a second central axis line CL2. Although details will be described later, each of the central axis lines CL0 to CL2 is substantially on the same straight line in a state where no external force is applied to the optical connection structure 1. Here, the term “substantially on the same straight line” includes the case where each of the central axis lines CL0 to CL2 can be considered to be on the same straight line if manufacturing errors, the influence of gravity, and the like are eliminated. Hereinafter, unless otherwise specified, the positional relationship of each part will be described in a state where no external force is applied to the optical connection structure 1. That is, the positional relationship of each part will be described in a state where each of the central axis lines CL0 to CL2 can be considered to be on the same straight line.

### (Direction Definition)

Here, in the present embodiment, a direction parallel to the first central axis line CL1 of the first fiber hole 11 (the reference central axis line CL0 of the through hole 41, the second central axis line CL2 of the second fiber hole 21) is referred to as a Z direction or an axial direction Z. A direction from the first ferrule 10 toward the second ferrule 20 along the axial direction Z is referred to as a +Z direction or a left side. A direction opposite to the +Z direction is referred to as a −Z direction or a right side. A cross section perpendicular to the axial direction Z is referred to as a transverse section. A direction perpendicular to the first central axis line CL1 of the first fiber hole 11 (the reference central axis line CL0 of the through hole 41, the second central axis line CL2 of the second fiber hole 21) is referred to as a radial direction. Along the radial direction, a direction approaching the first central axis line CL1 (the reference central axis line CL0, the second central axis line CL2) is referred to as an inner side in the radial direction, and a direction separated from the first central axis line CL1 (the reference central axis line CL0, the second central axis line CL2) is referred to as an outer side in the radial direction. A direction that orbits around the first central axis line CL1 (the reference central axis line CL0, the second central axis line CL2) when viewed from the axial direction Z is referred to as a circumferential direction.

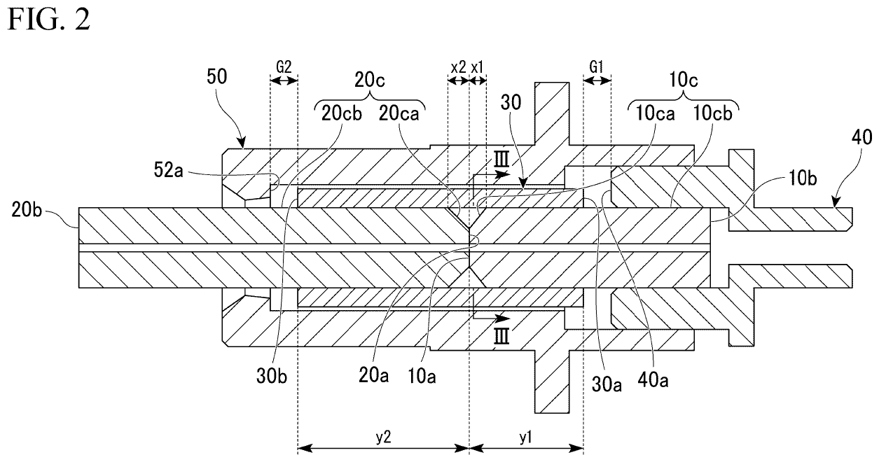

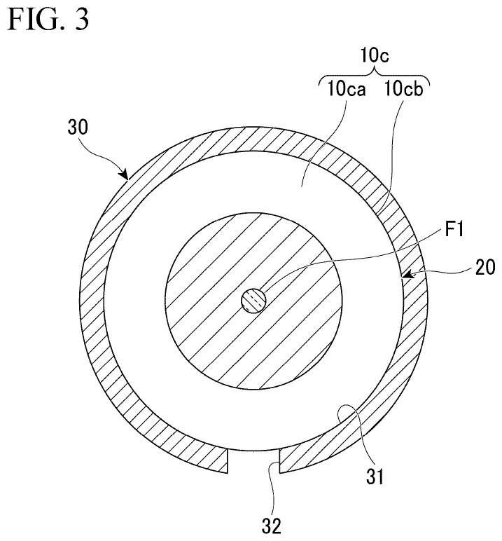

As shown in FIGS. 1 and 2, the first ferrule 10 has a first connection end surface 10a, a first rear end surface 10b, and a first side surface 10c. The first connection end surface 10a faces the left side and comes into contact with a second connection end surface 20a (described later) of the second ferrule 20. The first rear end surface 10b is located on a side opposite to the first connection end surface 10a and faces the right side. The first fiber hole 11 described above extends from the first connection end surface 10a to the first rear end surface 10b along the axial direction Z. The first side surface 10c extends from an outer circumferential edge of the first connection end surface 10a to an outer circumferential edge of the first rear end surface 10b. The first side surface 10c according to the present embodiment has a circular shape in the transverse sectional view (see also FIG. 3).

The first side surface 10c according to the present embodiment includes a first taper surface 10ca and a first extending surface 10cb. The first taper surface 10ca extends from the outer circumferential edge of the first connection end surface 10a to a left end of the first extending surface 10cb. The first extending surface 10cb extends from a right end of the first taper surface 10ca to the outer circumferential edge of the first rear end surface 10b. The first taper surface 10ca inclines so as to be gradually separated from the first fiber hole 11 (first central axis line CL1) in a direction from the first connection end surface 10a toward the first rear end surface 10b. In other words, the first taper surface 10ca inclines such that an outer diameter of the first ferrule 10 becomes gradually larger as a distance from the first connection end surface 10a increases. The first extending surface 10cb according to the present embodiment extends parallel to the axial direction Z (first central axis line CL1). In other words, the first extending surface 10cb extends such that the outer diameter of the first ferrule 10 is constant.

As shown in FIGS. 1 and 2, the second ferrule 20 has the second connection end surface 20a, a second rear end surface 20b, and a second side surface 20c. The second connection end surface 20a faces the right side and comes into contact with the first connection end surface 10a of the first ferrule 10. The second rear end surface 20b is located on a side opposite to the second connection end surface 20a and faces the left side. The second fiber hole 21 described above extends from the second connection end surface 20a to the second rear end surface 20b along the axial direction Z. The second side surface 20c extends from an outer circumferential edge of the second connection end surface 20a to an outer circumferential edge of the second rear end surface 20b. The second side surface 20c according to the present embodiment has a circular shape in the transverse sectional view.

The second side surface 20c according to the present embodiment includes a second taper surface 20ca and a second extending surface 20cb. The second taper surface 20ca extends from the outer circumferential edge of the second connection end surface 20a to a right end of the second extending surface 20cb. The second extending surface 20cb extends from a left end of the second taper surface 20ca to the outer circumferential edge of the second rear end surface 20b. The second taper surface 20ca inclines so as to be gradually separated from the second fiber hole 21 (second central axis line CL2) in a direction from the second connection end surface 20a toward the second rear end surface 20b. In other words, the second taper surface 20ca inclines such that an outer diameter of the second ferrule 20 becomes gradually larger as a distance from the second connection end surface 20a increases. The second extending surface 20cb according to the present embodiment extends parallel to the axial direction Z (second central axis line CL2). In other words, the second extending surface 20cb extends such that the outer diameter of the second ferrule 20 is constant.

The first fiber F1 is an optical fiber having a core (not shown) and a cladding (not shown). A left end (tip end) of the first fiber F1 is located on the first connection end surface 10a of the first ferrule 10. Further, the first fiber F1 extends to the right side from the first rear end surface 10b of the first ferrule 10. A right end (proximal end) of the first fiber F1 may be connected to, for example, an optical transceiver. As shown in the example of FIG. 1, a portion of the first fiber F1 located on the right side of the first rear end surface 10b may be coated with a coating member C, and the coating member C may be further covered with a tube T. The first fiber F1 according to the present embodiment is adhesively fixed in the through hole 41 of the support member 40 together with the coating member C and the tube T by an adhesive A.

The second fiber F2 is an optical fiber having a core (not shown) and a cladding (not shown), similarly to the first fiber F1. A right end (tip end) of the second fiber F2 is located on the second connection end surface 20a of the second ferrule 20. Further, the second fiber F2 extends to the left side from the second rear end surface 20b of the second ferrule 20. Although not shown, a portion of the second fiber F2 located on the left side of the second rear end surface 20b may be coated with the coating member C or the like, similarly to the first fiber F1.

As shown in FIGS. 1 and 2, the split sleeve 30 has a first end 30a facing the right side and a second end 30b facing the left side. Further, the split sleeve 30 is formed with an insertion hole 31 extending in the axial direction Z from the first end 30a to the second end 30b. At least part of the first ferrule 10 and at least part of the second ferrule 20 are inserted into the insertion hole 31. More specifically, the first ferrule 10 is inserted into the insertion hole 31 from the first end 30a, and the second ferrule 20 is inserted into the insertion hole 31 from the second end 30b. Inside the insertion hole 31, the first connection end surface 10a of the first ferrule 10 and the second connection end surface 20a of the second ferrule 20 come into contact with each other.

Further, as shown in FIG. 3, the split sleeve 30 is formed with a slit 32 that penetrates the split sleeve 30 in the radial direction and communicates with the insertion hole 31. Similarly to the insertion hole 31, the slit 32 extends in the axial direction Z from the first end 30a to the second end 30b of the split sleeve 30. With the insertion hole 31 and the slit 32 formed, the split sleeve 30 has a C-shape in the transverse section.

The split sleeve 30 is made of an elastic material (for example, resin, metal, or the like). In the present embodiment, an inner diameter of the insertion hole 31 is smaller than both the outer diameter of the first ferrule 10 (diameter of the first side surface 10c) and the outer diameter of the second ferrule 20 (second side surface 20c). Accordingly, when the first ferrule 10 and the second ferrule 20 are inserted into the insertion hole 31, the slit 32 is opened in the circumferential direction against an elastic restoring force of the split sleeve 30, and the split sleeve 30 is expanded. The expanded split sleeve 30 holds the first ferrule 10 and the second ferrule 20 in the insertion hole 31 by the elastic restoring force acting to reduce the inner diameter of the insertion hole 31. In order to stabilize holding by the split sleeve 30, it is preferable that the outer diameter of the first ferrule 10 and the outer diameter of the second ferrule 20 are substantially equal to each other. The term “substantially equal” includes the case where the two outer diameters can be considered equal if manufacturing errors are eliminated.

As shown in FIGS. 1 and 2, the support member 40 has a first contacting surface 40a facing the left side. The first contacting surface 40a faces the first end 30a of the split sleeve 30 in the axial direction Z. The through hole 41 of the support member 40 is open at the first contacting surface 40a and penetrates the support member 40 in the axial direction Z. The through hole 41 according to the present embodiment includes a ferrule accommodation portion 41a and an elongated portion 41b that communicate with each other. The ferrule accommodation portion 41a is open at the first contacting surface 40a. The ferrule accommodation portion 41a is a portion where at least part of the first ferrule 10 is inserted (accommodated) and supported (fixed). The elongated portion 41b is open at a right end of the support member 40. The elongated portion 41b is a portion through which a portion of the first fiber F1 extending from the first rear end surface 10b of the first ferrule 10 is inserted.

In order to stabilize holding of the first ferrule 10 by the support member 40, it is preferable that an inner diameter of the ferrule accommodation portion 41a and the outer diameter of the first ferrule 10 are equal to each other. However, in order to prevent the support member 40 from falling off to the right side with respect to the first ferrule 10, the inner diameter of the ferrule accommodation portion 41a may be slightly smaller than the outer diameter of the first ferrule 10.

An accommodation space 51 that penetrates the housing 50 in the axial direction Z is formed in the housing 50. The accommodation space 51 according to the present embodiment includes a sleeve accommodation portion 51a and a support member accommodation portion 51b that communicate with each other. The sleeve accommodation portion 51a is open at a left end of the housing 50. The sleeve accommodation portion 51a is a portion in which the split sleeve 30 is accommodated. The housing 50 also accommodates at least part of the first ferrule 10 and at least part of the second ferrule 20 together with the split sleeve 30. The support member accommodation portion 51b is open at a right end of the housing 50. The support member accommodation portion 51b is a portion in which at least part of the support member 40 is accommodated. The support member 40 according to the present embodiment is fixed to the housing 50 by press-fitting at least part of the support member 40 into the support member accommodation portion 51b.

As described above, the split sleeve 30 is expanded by the first ferrule 10 and the second ferrule 20. Therefore, an inner diameter of the sleeve accommodation portion 51a may be set to be slightly larger than an outer diameter of the split sleeve 30.

A protruding portion 52 protruding inward in the radial direction is provided on a left end portion of the sleeve accommodation portion 51a according to the present embodiment. The protruding portion 52 has a second contacting surface 52a facing the right side, and a guide surface 52b located on a side opposite to the second contacting surface 52a in the axial direction Z. The second contacting surface 52a faces the second end 30b of the split sleeve 30 in the axial direction Z. That is, the split sleeve 30 is disposed to be interposed between the first contacting surface 40a of the support member 40 and the second contacting surface 52a of the housing 50 in the axial direction Z. The guide surface 52b is a taper surface that inclines inward in the radial direction in the rightward direction. The guide surface 52b has a role of guiding the second ferrule 20 to the insertion hole 31 of the split sleeve 30 when the second ferrule 20 is inserted into the housing 50.

A claw portion 53 protruding outward in the radial direction is provided on an outer circumferential surface of the housing 50 according to the present embodiment. The claw portion 53 is disposed (loosely fitting) in a fitting groove 72 (described below) of the adapter 70.

The connector 60 according to the present embodiment includes a tubular main body portion 61, a handle 62, a spring push 63, a holding member 64, a restricting portion 65, and a biasing member 66. The handle 62 is provided with a stopper 62a. The stopper 62a is hooked onto a hooking portion 73 (described later) when the connector 60 is inserted into the adapter 70 (housing accommodation portion 71b), and prevents the connector 60 from falling off from the adapter 70.

The spring push 63 is formed in a tubular shape and is fixed to an inner circumferential surface of the main body portion 61. The restricting portion 65 according to the present embodiment is formed integrally with the main body portion 61, and protrudes inward in the radial direction from the inner circumferential surface of the main body portion 61. Further, the spring push 63 and the restricting portion 65 are disposed at an interval in the axial direction Z. The biasing member 66 and the holding member 64 are disposed between the spring push 63 and the restricting portion 65 in the axial direction Z. The biasing member 66 biases the holding member 64 rightward (toward the first ferrule 10). As the holding member 64, for example, a coil spring may be used. The shape of an inner circumferential surface of the restricting portion 65 corresponds to the shape of the spring push 63. Thereby, the restricting portion 65 prevents the holding member 64 from falling off to the right side of the connector 60 due to the biasing force of the biasing member 66. Note that the main body portion 61 and the restricting portion 65 may be separately formed, and the restricting portion 65 may be fixed to the inner circumferential surface of the main body portion 61.

In the present embodiment, the holding member 64 and the second ferrule 20 are fixed to each other. That is, the holding member 64 holds the second ferrule 20. In addition, a pipe P is coupled to the holding member 64 according to the present embodiment. As the material of the pipe P, for example, stainless steel can be adopted. The pipe P extends to the left side from the holding member 64 so as to penetrate the spring push 63. The pipe P covers and protects a portion of the second fiber F2 extending to the left side from the second rear end surface 20b of the second ferrule 20.

An internal space 71 that penetrates the adapter 70 in the axial direction Z is formed in the adapter 70. The internal space 71 according to the present embodiment includes a connector insertion portion 71a and a housing accommodation portion 71b that communicate with each other. The connector insertion portion 71a is open to the left side. The connector insertion portion 71a is a portion into which the connector 60 is inserted. The housing accommodation portion 71b is open to the right side. The housing accommodation portion 71b is a portion where the housing 50 is accommodated and fixed.

In the present embodiment, an inner diameter of the housing accommodation portion 71b is substantially equal to an outer diameter of the housing 50. Note that “substantially equal” includes the case where the inner diameter of the housing accommodation portion 71b and the outer diameter of the housing 50 can be considered equal if manufacturing errors are eliminated. Thereby, the housing 50 is prevented from moving relative to the adapter 70 in the radial direction. Further, the housing accommodation portion 71b is formed with the fitting groove 72 that is recessed outward in the radial direction from an inner circumferential surface of the housing accommodation portion 71b. The claw portion 53 of the housing 50 is disposed in the fitting groove 72. Thereby, the housing 50 is prevented from moving relative to the adapter 70 in the axial direction Z.

Further, the adapter 70 according to the present embodiment has the hooking portion 73. The hooking portion 73 hooks the stopper 62a when the connector 60 is inserted into the housing accommodation portion 71b, and prevents the connector 60 from falling off from the adapter 70.

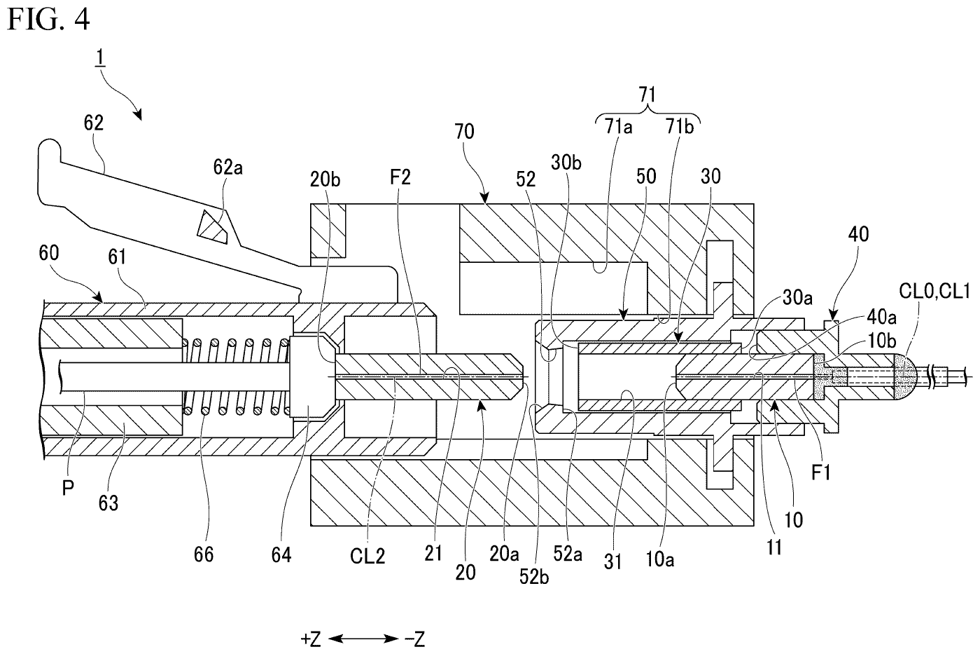

In the optical connection structure 1 described above, when connecting the first fiber F1 and the second fiber F2, as shown in FIG. 4, the connector 60 is inserted into the connector insertion portion 71a of the adapter 70. When the connector 60 is inserted into the connector insertion portion 71a, the second ferrule 20 held by the holding member 64 is guided to the insertion hole 31 of the split sleeve 30 by the guide surface 52b described above. When the connector 60 is further inserted, the second connection end surface 20a of the second ferrule 20 and the first connection end surface 10a of the first ferrule 10 come into contact with each other inside the insertion hole 31. Thereby, the first fiber F1 and the second fiber F2 are optically connected to each other.

When the connector 60 is further pushed into the adapter 70, the biasing member 66 is contracted in the axial direction Z. In this case, the second ferrule 20 is biased toward the first ferrule 10 by the elastic restoring force (biasing force) of the biasing member 66. When the insertion of the connector 60 is completed, the stopper 62a is hooked onto the hooking portion 73, and thus the connector 60 is unlikely to fall off from the adapter 70. When the insertion of the connector 60 is completed, the second ferrule 20 is supported by the rightward biasing force of the biasing member 66, the leftward reaction force by the first ferrule 10, and the elastic restoring force of the split sleeve 30 directed inward in the radial direction. Further, at this time, under an ideal state where no external force is applied to the optical connection structure 1, the first central axis line CL1 of the first ferrule 10, the second central axis line CL2 of the second ferrule 20, and the reference central axis line CL0 of the support member 40 are located substantially on the same straight line.

When disconnecting the connection between the first fiber F1 and the second fiber F2, the connector 60 is removed from the adapter 70. In this case, as necessary, the handle 62 may be elastically deformed to separate the stopper 62a from the hooking portion 73. Since the second ferrule 20 is fixed (held) to the holding member 64, when the connector 60 is removed from the adapter 70, the second ferrule 20 follows the connector 60 and is separated from the first ferrule 10. Thereby, the optical connection between the first fiber F1 and the second fiber F2 is disconnected.

As described above, in the optical connection structure 1 according to the present embodiment, the first fiber F1 and the second fiber F2 can be connected to each other or the connection can be disconnected by inserting or removing the connector 60 into or from the adapter 70.

Hereinafter, a dimension of each part of the optical connection structure 1 according to the present embodiment will be described.

In a state where the fibers F1 and F2 are connected, when an external force (wiggle) is applied to the second ferrule 20 via the connector 60, the pipe P, the second ferrule 20, or the like, the second ferrule 20 may move relative to the first ferrule 10. Such a relative movement is particularly likely to occur in an optical connection structure in which one ferrule (second ferrule 20) is biased by a biasing member, and the other ferrule (first ferrule 10) is not biased by a biasing member and is supported (fixed) by a support member. This is because the second ferrule 20 moves with the elastic deformation of the biasing member, but the first ferrule 10 is fixed to the support member and is less likely to follow the movement of the second ferrule 20.

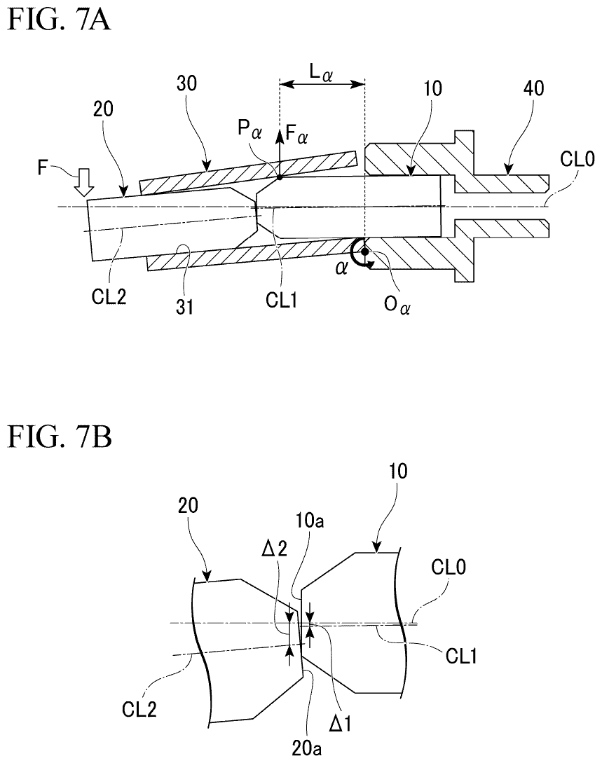

Examples of the types of relative movement of the second ferrule 20 with respect to the first ferrule 10 include three types of “axes misalignment”, “tilt”, and “separation”. The “axes misalignment” is a phenomenon in which the center of the first fiber hole 11 on the first connection end surface 10a and the center of the second fiber hole 21 on the second connection end surface 20a are misaligned in a direction perpendicular to the axial direction Z (see also FIG. 7B). The “tilt” is a phenomenon in which the second central axis line CL2 is tilted with respect to the first central axis line CL1. The term “separation” is a phenomenon in which the first connection end surface 10a and the second connection end surface 20a are separated from each other in the axial direction Z. When the above-described “axes misalignment”, “tilt”, and “separation” occur, connection loss between the first ferrule 10 (first fiber F1) and the second ferrule 20 (second fiber F2) is likely to increase.

As a result of diligent studies of the inventors of the present application, the inventors have found that among the above-described three phenomena, the “axes misalignment” is particularly likely to cause a large connection loss increase. Therefore, the inventors of the present application have investigated a relationship between the axes misalignment increment Δ and the magnitude of the connection loss increase by simulation. Here, in the present specification, the “axes misalignment increment Δ” is defined as a distance, in the direction perpendicular to the axial direction Z, between the center (first central axis line CL1) of the first fiber hole 11 on the first connection end surface 10a and the center (second central axis line CL2) of the second fiber hole 21 on the second connection end surface 20a. Table 1 is obtained by summarizing the results of the investigation.

TABLE 1

| AXES | | CONNECTION LOSS INCREASE (dB) | | | |
|---|---|---|---|---|---|
| MISALIGNMENT | | MFD | MFD | MFD | MFD |
| INCREMENT Δ | | 7.4 μm | 9.6 μm | 10.4 μm | 11.2 μm |
| 0 | μm | 0 | 0 | 0 | 0 |
| 0.44 | μm | 0.5 | 0.3 | 0.2 | 0.2 |
| 0.50 | μm | 0.6 | 0.3 | 0.3 | 0.2 |
| 0.80 | μm | 1.0 | 0.6 | 0.5 | 0.4 |
| 1.10 | μm | 1.5 | 0.9 | 0.7 | 0.6 |
| 1.35 | μm | 1.9 | 1.1 | 1.0 | 0.8 |
| 1.60 | μm | 2.4 | 1.4 | 1.2 | 1.0 |
| 1.85 | μm | 2.9 | 1.7 | 1.5 | 1.3 |

In the above investigation, it was assumed that the value of the mode field diameter (MFD) of the first fiber F1 and the value of the MFD of the second fiber F2 are equal to each other. In addition, as for the values of MFD of the fibers F1 and F2, the value of MFD of an optical fiber widely and generally used in the industry was adopted. In addition, it was assumed that the above-described “tilt” and “separation” did not occur.

As shown in Table 1, regardless of the values of MFD of the fibers F1 and F2, the larger the axes misalignment increment Δ, the larger the connection loss increase, and the smaller the axes misalignment increment Δ, the smaller the connection loss increase. It is preferable that the connection loss increase is, for example, 1.0 dB or less. According to Table 1, it can be seen that regardless of the values of MFD of the fibers F1 and F2, the connection loss increase can be reduced to 1.0 dB or less by reducing the axes misalignment increment Δ to 0.50 μm or less.

Accordingly, the inventors of the present application have considered that it is preferable to adopt a configuration in which the axes misalignment increment Δ can be reduced to 0.50 μm or less even when an external force is applied to the second fiber F2 in manufacturing the optical connection structure 1. As shown in Table 1, even when the axes misalignment increment Δ is 0.80 μm, it is possible to reduce the connection loss increase to 1.0 dB or less. However, in consideration of manufacturing errors or the like, the axes misalignment increment Δ caused by the external force may vary. Accordingly, it is considered preferable to adopt a configuration in which the axes misalignment increment Δ is reduced to 0.50 μm or less as described above.

Although details will be described later, the inventors of the present application have found that it is possible to reduce the axes misalignment increment Δ by appropriately setting parameters X and Y defined below, for the first ferrule 10 and the second ferrule 20. The parameters X and Y are defined by the following expressions a and b (see also FIG. 2).

$$a : X = x 1 / x 2 \\ b : Y = y 1 / y 2$$

Here, the dimensions x1, x2, y1, and y2 are defined as follows.
x1: Dimension of the first taper surface 10ca in a direction (axial direction Z) in which first fiber hole 11 extends
x2: Dimension of the second taper surface 20ca in a direction (axial direction Z) in which the second fiber hole 21 extends
y1: Distance between the first connection end surface 10a and the first end 30a in the direction (axial direction Z) in which the first fiber hole 11 extends (that is, an insertion length of the first ferrule 10 into the split sleeve 30)
y2: Distance between the second connection end surface 20a and the second end 30b in the direction (axial direction Z) in which the second fiber hole 21 extends (that is, an insertion length of the second ferrule 20 into the split sleeve 30)

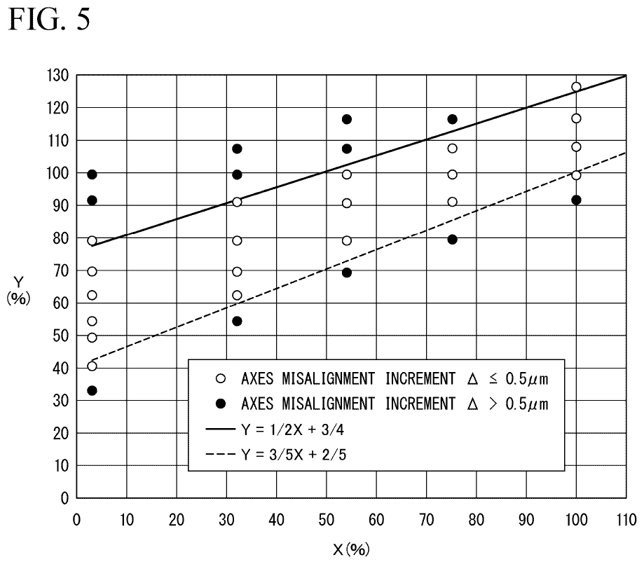

Table 2 is obtained by summarizing the results of investigating the values of the axes misalignment increment Δ caused by the external force by simulation, with respect to the parameters X and Y. FIG. 5 is a graph obtained by summarizing the results of Table 2. The simulation of the axes misalignment increment Δ was performed in accordance with the standard of Method A of IEC62150-3. More specifically, the optical connection cord specified in the above standard was used as the second fiber F2, and the simulation was performed assuming that an external force (wiggle) of 1.5 N was applied to the optical connection cord.

TABLE 2

| | | AXES MISALIGNMENT INCREMENT Δ (μm) | | | | | | | | | | | |
|---|---|---|---|---|---|---|---|---|---|---|---|---|---|
| | | Y (%) | | | | | | | | | | | |
| | | 33% | 41% | 50% | 55% | 63% | 70% | 80% | 92% | 100% | 108% | 117% | 127% |
| X | 100% | | | | | 1.90 | 1.40 | 1.30 | 0.70 | 0.40 | 0.10 | 0.40 | 0.50 |
| (%) | 75% | | | | | 1.60 | 1.20 | 0.80 | 0.14 | 0.04 | 0.18 | 0.57 | |
| | 54% | | | | | 1.10 | 0.80 | 0.40 | 0.20 | 0.50 | 0.70 | 0.77 | |
| | 32% | | | 0.98 | 0.66 | 0.50 | 0.30 | 0.05 | 0.31 | 0.53 | 0.66 | | |
| | 3% | 0.72 | 0.38 | 0.16 | 0.00 | 0.10 | 0.32 | 0.40 | 0.80 | 0.76 | 1.12 | | |

As shown in FIG. 5, it can be seen that, in a set of the parameters X and Y that satisfies the following expression c, the axes misalignment increment Δ is 0.50 μm or less even when the external force is applied.

$$c : ( 3 X + 2 ) / 5 < Y < ( 2 X + 3 ) / 4$$

That is, by setting the dimensions x1 and x2 of the tapered surfaces 10ca and 20ca and the insertion lengths y1 and y2 of the ferrules 10 and 20 to satisfy the expression c, it is possible to reduce the axes misalignment increment Δ, and to reduce the connection loss increase of the optical connection structure 1.

The mechanism by which the value of the axes misalignment increment Δ is changed by changing the parameters X and Y is considered as follows.

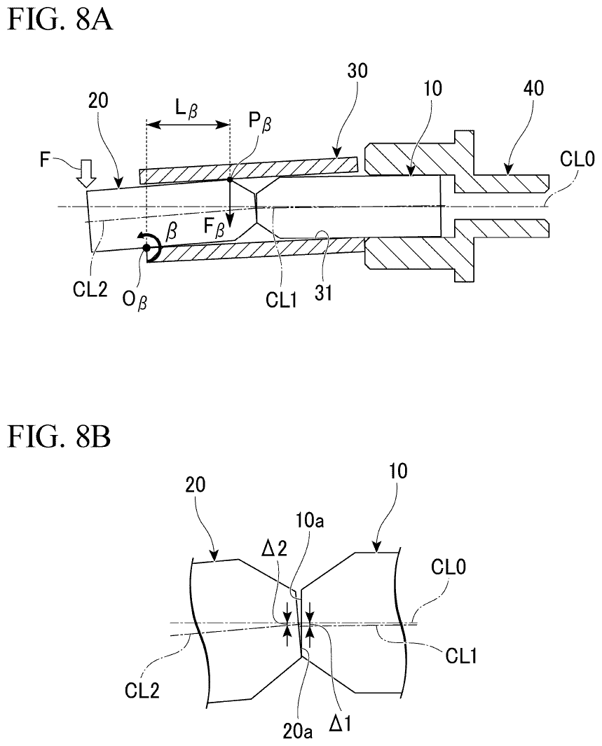

The inventors of the present application have considered that the first ferrule 10, the second ferrule 20, and the split sleeve 30 perform a first movement, a second movement, and a third movement described in detail below, when an external force F is applied to the second fiber F2 (see FIGS. 6A, 7A, and 8A). The first movement is a movement in which the first ferrule 10 rotates within the ferrule accommodation portion 41a together with the split sleeve 30 and the second ferrule 20 (see FIG. 6A). The second movement is a movement in which the split sleeve 30 rotates around the first end 30a as a fulcrum together with the second ferrule 20 (see FIG. 7A). The third movement is a movement in which the second ferrule 20 rotates around the second end 30b as a fulcrum (see FIG. 8A). The first to third movements described above may occur at the same time. Hereinafter, the second movement may be referred to as rotation α, and the third movement may be referred to as rotation β. During the rotation α and the rotation β, the split sleeve 30 can be elastically deformed such that the insertion hole 31 is expanded.

Among the above-described three movements, in the first movement, the relative positions of the first ferrule 10 and the second ferrule 20 do not change. Therefore, as shown in FIG. 6B, the axes misalignment increment Δ can be regarded as 0. More specifically, the first central axis line CL1 of the first fiber hole 11 and the second central axis line CL2 of the second fiber hole 21 are inclined at the same angle with respect to the reference central axis line CL0 of the through hole 41. At this time, a deviation (absolute value of the deviation) Δ1 of the first central axis line CL1 with respect to the reference central axis line CL0 on the first connection end surface 10a and a deviation (absolute value of the deviation) Δ2 of the second central axis line CL2 with respect to the reference central axis line CL0 on the second connection end surface 20a are considered to be equal to each other. Here, since the axes misalignment increment Δ is represented by |Δ1−Δ2| and Δ1=Δ2 in the first movement, it can be regarded that the axes misalignment increment Δ=0. That is, it is considered that the first movement does not affect the axes misalignment increment Δ.

In the second movement (rotation α), the second ferrule 20 and the split sleeve 30 move relative to the first ferrule 10. Therefore, as shown in FIG. 7B, the rotation α affects the axes misalignment increment Δ. More specifically, the tilt of the second central axis line CL2 with respect to the reference central axis line CL0 is larger than the tilt of the first central axis line CL1 with respect to the reference central axis line CL0. At this time, Δ2 is larger than Δ1 (Δ2>Δ1). Accordingly, the axes misalignment increment Δ=|Δ2−Δ1|>0.

In the third movement (rotation β), the second ferrule 20 moves relative to the first ferrule 10. Therefore, as shown in FIG. 8B, the rotation β also affects the axes misalignment increment Δ. However, during the rotation β, the second ferrule 20 rotates such that the deviation Δ2 is reduced. Namely, a direction of the deviation Δ2 caused by the rotation α and a direction of the deviation Δ2 caused by the rotation β are opposite to each other. Accordingly, it is considered that, by appropriately balancing the amount of rotation α and the amount of rotation β to adjust the magnitude of Δ2 such that the value of |Δ2−Δ1| is reduced, the axes misalignment increment Δ can be reduced.

Here, the influence of the magnitude of the parameter Y on the rotation α will be considered. Regarding a moment of the rotation α around a fulcrum Oα shown in FIG. 7A, when the second ferrule 20 and the split sleeve 30 are regarded as integrated, it is considered that a moment M caused by the external force F and a moment Mα caused by the elastic restoring force Fα of the split sleeve 30 are balanced. Here, according to the above-described definition, the larger the parameter Y, the larger the dimension y1 and the smaller the dimension y2 (see also FIG. 2). That is, the larger the parameter Y, the more the first connection end surface 10a and the second connection end surface 20a move to the left side. Accordingly, the larger the parameter Y, the more an action point Pa of the elastic restoring force Fα moves to the left side, and the larger a distance La from the fulcrum Oα to the action point Pa becomes. Since the moment Mα is represented by the product of the elastic restoring force Fα and the distance Lα, the larger the distance Lα, the smaller the magnitude of the elastic restoring force Fα that satisfies the expression of (M=)Mα=Fα×Lα. Here, it is considered that the smaller the elastic restoring force Fα, the smaller the rotation α. This is because it is considered that the larger the rotation α, the stronger the first ferrule 10 is pushed against an inner circumferential surface of the insertion hole 31, and the larger the elastic restoring force Fα.

From the above consideration, it is considered that the larger the parameter Y, the smaller the magnitude of the elastic restoring force Fα that prevents the rotation of the second ferrule 20 and the split sleeve 30, and thus the smaller the rotation α.

Next, the influence of the magnitude of the parameter Y on the rotation β will be considered. Regarding a moment of the rotation β around a fulcrum Oβ shown in FIG. 8A, it is considered that a moment M caused by the external force F and a moment Mβ caused by the elastic restoring force Fβ of the split sleeve 30 are balanced. Similarly to the above consideration, the larger the parameter Y, the more an action point PB of the elastic restoring force Fβ moves to the left side, and the smaller a distance Lβ from the fulcrum Oβ to the action point PB becomes. Since Mβ=Fβ×Lβ, the smaller the distance Lβ, the larger the elastic restoring force Fβ needs to be. Here, it is considered that the larger the elastic restoring force FB, the larger the rotation β. This is because it is considered that the larger the rotation β, the stronger the second ferrule 20 is pushed against the inner circumferential surface of the insertion hole 31, and the larger the elastic restoring force Fβ.

From the above consideration, it is considered that the larger the parameter Y, the larger the elastic restoring force Fβ that prevents the rotation of the split sleeve 30, and thus the larger the rotation β.

Next, the influence of the magnitude of the parameter X on the rotation α will be considered. From the above-described definition, the larger the parameter X, the larger the dimension x1 of the first taper surface 10ca (see also FIG. 2). Therefore, the larger the parameter X, the more the action point Pa of the elastic restoring force Fα moves to the right side, and the smaller the distance La from the fulcrum Oα to the action point Pa is (see FIG. 7A).

Accordingly, by considering in the same manner as the influence of the magnitude of the parameter Y on the rotation α, a result is derived that the larger the parameter X is, the larger the rotation α.

Next, the influence of the magnitude of the parameter X on the rotation β will be considered. From the above-described definition, the larger the parameter X, the smaller the dimension x2 of the second taper surface 20ca (see also FIG. 2). Therefore, the larger the parameter X, the more the action point Pβ of the elastic restoring force Fβ moves to the right side, and the larger the distance Lβ from the fulcrum Oβ to the action point Pβ becomes (see FIG. 8A).

Accordingly, by considering in the same manner as the influence of the magnitude of the parameter Y on the rotation β, a result is derived that the larger the parameter X is, the smaller the rotation β.

As described above, the parameter X and the parameter Y both affect the magnitudes of the rotations α and β. Accordingly, it is considered that the axes misalignment increment Δ can be reduced as shown in Table 2 and FIG. 5 by appropriately setting the parameter X and the parameter Y such that the amount of the rotation α and the amount of the rotation β are appropriately balanced.

Incidentally, as described above, the ferrules 10 and 20 are supported by the elastic restoring force of the split sleeve 30. Accordingly, when the second ferrule 20 is repeatedly inserted into and removed from the split sleeve 30, the split sleeve 30 may move in the axial direction Z inside the housing 50 due to the frictional force acting between the second ferrule 20 and the split sleeve 30. More specifically, there is a possibility that the split sleeve 30 may move within a range of a distance (gap) G1 and a distance (gap) G2 shown in FIG. 2. Here, the distance G1 is a distance between the first end 30a of the split sleeve 30 and the first contacting surface 40a of the support member 40 in the direction (axial direction Z) in which the first fiber hole 11 extends. The distance G2 is a distance between the second end 30b of the split sleeve 30 and the second contacting surface 52a of the housing 50 in the direction (axial direction Z) in which the second fiber hole 21 extends.

When the split sleeve 30 moves inside the housing 50 as described above, the insertion lengths y1 and y2 of the ferrules 10 and 20 and the value of the parameter Y change. In this case, the magnitudes of the rotations α and β change, and there is a possibility that the connection loss between the ferrules 10 and 20 may increase.

On the other hand, in the optical connection structure 1 according to the present embodiment, G1+G2≤0.45 mm is established. With this configuration, the movement of the split sleeve 30 is prevented, and changes in the insertion lengths y1 and y2 of the ferrules 10 and 20 are reduced. Accordingly, it is possible to more reliably reduce an increase in the connection loss between the ferrules 10 and 20.

As described above, the optical connection structure 1 according to the present embodiment includes the first ferrule 10 having the first connection end surface 10a, the second ferrule 20 having the second connection end surface 20a that comes into contact with the first connection end surface 10a, and the split sleeve 30 that has the insertion hole 31 into which at least part of the first ferule 10 and at least part of the second ferule 20 are inserted and has a C-shape in the transverse section perpendicular to the direction (axial direction Z) in which the insertion hole 31 extends, in which the split sleeve 30 has the first end 30a in which the first ferrule 10 is inserted and the second end 30b which is located opposite to the first end 30a and in which the second ferrule 20 is inserted, the first ferule 10 has the first fiber hole 11 that penetrates the first ferule 10 and the first taper surface 10ca that inclines such that the diameter thereof becomes gradually larger as the distance from the outer circumferential edge of the first connection end surface 10a increases, the second ferrule 20 has the second fiber hole 21 that penetrates the second ferrule 20 and the second taper surface 20ca that inclines such that the diameter thereof becomes gradually larger as the distance from the outer circumferential edge of the second connection end surface 20a increases, and when assuming that the dimension of the first taper surface 10ca in the direction (axial direction Z) in which the first fiber hole 11 extends is x1, the distance between the first connection end surface 10a and the first end 30a is y1, the dimension of the second taper surface 20ca in the direction (axial direction Z) in which the second fiber hole 21 extends is x2, and the distance between the second connection end surface and the second end 30b is y2, the following expressions a, b, and c are established.

$$a : X = x 1 / x 2 \\ b : Y = y 1 / y 2 \\ c : ( 3 X + 2 ) / 5 < Y < ( 2 X + 3 ) / 4$$

With this configuration, it is possible to reduce an increase (axes misalignment increment Δ) in the axes misalignment between the first fiber F1 and the second fiber F2 when an external force is applied to the ferrules 10 and 20. Thereby, it is possible to reduce an increase in the connection loss between the first fiber F1 and the second fiber F2.

Further, the optical connection structure 1 according to the present embodiment further includes the support member 40 that supports at least part of the first ferrule 10, and the housing 50 that accommodates the split sleeve 30, in which the support member 40 has the first contacting surface 40a facing the first end 30a, the housing 50 has the second contacting surface 52a facing the second end 30b, and when assuming that the distance between the first end 30a and the first contacting surface 40a in the direction (axial direction Z) in which the first fiber hole 11 extends is G1, and the distance between the second end 30b and the second contacting surface 52a in the direction (axial direction Z) in which the second fiber hole 21 extends is G2, G1+G2≤0.45 mm is established. With this configuration, the movement of the split sleeve 30 can be restricted even when the ferrules 10 and 20 are repeatedly inserted into and removed from the split sleeve 30. Thereby, the insertion lengths y1 and y2 of the ferrules 10 and 20 into the split sleeve 30 are less likely to change, and it is possible to more reliably reduce an increase in the connection loss between the first fiber F1 and the second fiber F2.

Further, the second ferrule 20 is biased toward the first ferrule 10 by the biasing member 66, and the first ferrule 10 is not biased toward the second ferrule 20. In an optical connection structure in the related art, when one of two ferrules is biased by a biasing member and the other is not biased by the biasing member, axes misalignment is likely to increase. On the other hand, according to the optical connection structure 1 of the present embodiment, even in such a case, it is possible to reduce the axes misalignment increment Δ between the first fiber F1 and the second fiber F2, and to reduce an increase in the connection loss.

A technical scope of the present invention is not limited to the above-described embodiments, and it is possible to have various modifications be made within a scope that does not depart from the gist of the present invention.

For example, the configurations of the support member 40, the housing 50, the connector 60, the adapter 70, the first fiber F1, the second fiber F2, and the like in the above embodiment are all examples, and these members may be appropriately changed.

Further, a plurality of first fiber holes 11 may be formed in the first ferrule 10. Similarly, a plurality of second fiber holes 21 may be formed in the second ferrule 20.

Further, in the above-described embodiment, the shape of the first side surface 10c of the first ferrule 10 is circular in the transverse sectional view, but may be rectangular or other shapes. Similarly, the shape of the second side surface 20c of the second ferrule 20 may not be circular.

Further, it is possible to appropriately replace the configuring components in the above-described embodiment with well-known configuring components, and the above-described embodiment and modification examples may be appropriately combined within a scope that does not depart from the gist of the present invention.

### REFERENCE SIGNS LIST

1: Optical connection structure
10: First ferrule
10a: First connection end surface
10ca: First taper surface
11: First fiber hole
20: Second ferrule
20a: Second connection end surface
20ca: Second taper surface
21: Second fiber hole
30: Split sleeve
30a: First end
30b: Second end
40: Support member
40a: First contacting surface
50: Housing
52a: Second contacting surface
66: Biasing member

1. An optical connection structure comprising:
a first ferrule having a first connection end surface;
a second ferrule having a second connection end surface that comes into contact with the first connection end surface; and
a split sleeve that has an insertion hole into which at least part of the first ferule and at least part of the second ferule are inserted and has a C-shape in a transverse section perpendicular to a direction in which the insertion hole extends,
wherein the split sleeve has a first end in which the first ferrule is inserted and a second end which is located opposite to the first end and in which the second ferrule is inserted,
the first ferule has a first fiber hole that penetrates the first ferule and a first taper surface that inclines such that a diameter thereof becomes gradually larger as a distance from an outer circumferential edge of the first connection end surface increases,
the second ferrule has a second fiber hole that penetrates the second ferrule and a second taper surface that inclines such that a diameter thereof becomes gradually larger as a distance from an outer circumferential edge of the second connection end surface increases, and
when assuming that a dimension of the first taper surface in a direction in which the first fiber hole extends is x1, a distance between the first connection end surface and the first end in the direction in which the first fiber hole extends is y1, a dimension of the second taper surface in a direction in which the second fiber hole extends is x2, and a distance between the second connection end surface and the second end in the direction in which the second fiber hole extends is y2, the following expressions a, b, and c are established.
$$a : X = x 1 / x 2 \\ b : Y = y 1 / y 2 \\ c : ( 3 X + 2 ) / 5 < Y < ( 2 X + 3 ) / 4$$

2. The optical connection structure according to claim 1, further comprising:
a support member that supports at least part of the first ferrule; and
a housing that accommodates the split sleeve,
wherein the support member has a first contacting surface facing the first end,
the housing has a second contacting surface facing the second end, and
when assuming that a distance between the first end and the first contacting surface in the direction in which the first fiber hole extends is G1, and a distance between the second end and the second contacting surface in the direction in which the second fiber hole extends is G2, G1+G2≤0.45 mm is established.

3. The optical connection structure according to claim 1, wherein
the second ferrule is biased toward the first ferrule by a biasing member, and
the first ferrule is not biased toward the second ferrule.
